(19) United States
(12) Patent Application Publication
(10) Pub. No.: US 2009/0075739 A1
(43) Pub. Date: Mar. 19, 2009

(54) Computerized Gaming Devices and Methods

(76) Inventor: Joseph J. Richardson, Fargo, ND (US)

Correspondence Address: MOORE & HANSEN, PLLP, 225 SOUTH SIXTH ST, MINNEAPOLIS, MN, 55402, US

(21) Appl. No.: 12/212,251

(22) Filed: Sep. 17, 2008

Related U.S. Application Data
(60) Provisional application No. 60/973,272, filed on Sep. 18, 2007.

(51) Int. Cl. A63F 13/00

(52) U.S. Cl. 463/42

(57) ABSTRACT

Play stations or terminals for playing computerized games having at least one game lot, each game lot having a plurality of chances including a finite number of losing chances and a finite number of winning chances. The plurality of chances are provided for random purchase via one of the play stations. The preferred play station including a display that notifies the player of real time status information including: 1) the frequency of game lot chances purchased on the network; 2) the average profit or payout expectancy; 3) the actual profit or payout experience; and/or 4) the number of other players actively purchasing chances from the same game lot on the network. The present invention further includes methods of displaying such real time status of a computerized game on a computer gaming network.

### RELATED APPLICATIONS

The present application is related to and claims priority to U.S. Provisional Patent Application Ser. No. 60/973,272 filed Sep. 18, 2007 entitled COMPUTERIZED GAMING DEVICES AND METHODS, the disclosure of which is hereby incorporated by reference.

### BACKGROUND OF THE DISCLOSURE

1. Field of the Invention

The present invention relates to computerized gaming devices wherein a plurality of game lots are provided for selection by a player, with each game lot has a plurality of randomly purchasable chances including a predetermined plurality of winning chances each having a preset prize value. The present invention further relates to computerized gaming devices including a display that notifies the player of at least one of the following: 1) the frequency of game lot chances being purchased on the network during a set period of time; 2) the average profit or payout expectancy; and/or 3) the actual profit or payout experience.

2. Description of the Related Art

Pull-tab games in paper form have existed for many years and are commonly played in state regulated charitable gambling institutions. Likewise, computerized gaming machines simulating casino slot machine games are common.

One known game is in the form of paper tickets packaged in fixed number lots with a fixed payout and therefore, fixed profit. Such games typically vary in size from approximately 1,000 to 4,000 chances per lot or deal; and the payouts typically vary from deal to deal from a low of about 60% to a high of about 84%. The payout of such games is often in five or six tiers: 4 winning tickets in the highest tier, 4 winning tickets in the second tier, 4 winning tickets in the third tier, 12 winning tickets in the fourth tier, and 200 small winners which often return only 1 or 2 times the cost of a ticket.

Many state regulations require that non-profit organizations who operate charitable gaming tickets (CGTs) place all of the tickets from a deal in a transparent container. This allows the players to see that winning tickets are not pulled from a separate place, envelope, or pocket as they often were back when carnivals used this type of game. By looking at the container, players are able to visually estimate the number of tickets or chances left in that container. State regulations often require that an organization display what is called a “flare” for each game. The flare is a poster which shows the player: which symbols constitute a winner, the value winning tickets award, and how many winners of each level there are in the game prior to play having commenced in a particular game lot of chances. The flare also may indicate what the payout percentage is for the entire game, and/or total ticket count, and/or the odds of hitting a winner when the game is new and assuming all chances are purchased (hit frequency). Furthermore, in some jurisdictions some organizations mark off winners on the flare as those winners are redeemed. This allows a player to know how many large winners remain in the deal at any given time and what the respective values of those remaining winners are. Some organizations take the games out of play as soon as all of the “major winners” have been redeemed. “Major winners” are commonly referred to as those which are 50 times the bet and above. Thus, played in this way an organization can actually take a loss on a deal if all of the major winners are redeemed before enough tickets have been sold to realize a profit. All of these factors combined contribute to making CGTs one of the most straight-forward and fair games. In order to determine profit and loss on a per deal basis, organizations often maintain separate banks for each deal.

One computerized gaming device and method of playing casino-type games of chance is disclosed in U.S. Pat. No. 5,042,809 (Richardson). In this computerized gaming device and method, a player chooses a game to play from a plurality of games displayed on a video screen. Each game has a finite number of chances per deal and a video display showing the quantity of winning chances at each prize level when a deal or lot of chances is new, the aggregate quantity of major winning chances remaining as it is played, and the possible winning symbol combinations. In addition, a displayed record is kept of the player's cash credit with a print out of wins and losses when he quits to claim any winnings. A provision is made to retire a deal or game whenever all the major winning chances have been won or when there are no more major winning chances remaining. The player can quit at any time or call for a new set of chances after playing at least one chance in a displayed set of chances.

The present invention provides improvements which address these and other limitations associated with the prior art.

### SUMMARY OF THE INVENTION

The present invention includes methods and devices for calibrating and visually displaying the frequency of chances sold during a set period of time from each game concurrently available to be accessed by player stations on the same common casino game memory server of a network. The methods of the present invention include providing players at electronic wagering gaming terminals or play stations an indication of the frequency at which chances are selling from each game lot offered from an entire network of gaming terminals. By so informing players, an aura of excitement is created. This is especially the case when a plethora of gaming terminals or play stations are all accessing the same game lot having a finite quantity chances that include a pre-determined quantity of winning and losing chances. Preferably, the quantity of winning chances includes a plurality of major winning chances having a value significantly higher than the cost of randomly purchasing one of the plurality of chances. A player on one terminal or at one player station or when viewing a game promotional sign, that includes this feature, considers his competitive prospects for randomly purchasing a winning chance when there are a finite quantity of chances available, when he has information as to the frequency of chances being vended to all terminals accessing the same game lot, thus often increasing the desire to play. In recognizing the frequency of chances being sold for a particular game lot, a player can gauge how much competition they have in attempting to win or purchase one of the randomly selected remaining winning chances. Some players may enjoy the competitive play while others may not appreciate the competition. A game promotional sign is preferably an electronic sign external to the play stations that provides a list of available game lots or progressive prize linked games and also shows a game activity meter for each game lot promoted.

In preferred embodiments, the methods include providing information regarding how fast the plurality of chances are being vended on the multi-terminal network offering the same progressive prize as in a statewide lottery terminal network wherein all players are seeking a common prize offered throughout the state or plurality of states with regard for multi-state progressive lotteries. Game activity meters, which can be utilized to notify or display the frequency at which chances are selling on a network of gaming terminals, can be a visual representation of the scale parameter input (the quantity of chances sold from a particular game lot over a given recent time interval). In preferred embodiments, the visual representations can be icons, numerals or the like that are provided by the game activity meter.

To compliment the information provided by the game activity meters, preferably information is displayed regarding how many other play stations or players are accessing the same game lot having a finite number or lot of chances. This can be of interest to players, who in effect, are competing for the remaining large or major winners in such game lots. It is believed that the value of knowing how many players are accessing a particular game lot is diminished as the quantity of play stations increases. Hence, this feature is preferably utilized with networks comprised of a small quantity (i.e. less than about 100, more preferable less than 30) of player stations accessing the same predetermined finite number of chances from a single game lot.

In preferred embodiments, the average profit or payout expectancy and the actual profit or payout experience are displayed on the display or game screen. Some wagering/gaming jurisdictions require that players receive information on either the percentage a game pays out or the percentage of profit expected from the game, assuming all chances are purchased before the game lot is retired or completed. In some jurisdictions where competition is restricted to state lottery games, this actually has provided a competitive advantage to charity games as they tend to payout significantly higher percentages than state lotteries. However, where charities are competing with casinos whose slot machines pay out a higher percentage, understated charity payouts have been disadvantageous. The percentages often posted for payouts of charity pulltab ticket games are as understated as profits are overstated when a game is retired after all the major winning chances have been won. Preferably, the game design company utilizing the present invention will set the average profit or payout expectancy, which is a static statistic, and persons with access to the electronic gaming network settings can set the quantity of game lots that are to be retired or completed before the statistic converts to actual profit or payout experience, respectively, which are dynamic statistics. Displaying the average profit or payout expectancy and then experience will allow players a more accurate understanding of the competitive advantages these charity games provide.

In finite probability games of chance where the game lot in play can be permanently retired or completed before all of the chances in a given game lot are sold, the profit can vary. The preferred trigger for retiring a given game lot is when all of the major winners or winning chances in the lot have been won. If no such major winners remain within the pool, players are not likely to be attracted to play the game lot.

The concept of “beating the house” is statistically incalculable without having a fixed quantity of chances that are retired based on the random appearance of a present quantity of winning chances paying a certain level of prize. Continuum-based electronic games cannot provide any given point in time whereby a player could meaningfully be said to have “beat the house.” Likewise, players of charity pulltab games that are played through the last remaining chances, and not retired early based on the appearance of winning chances, never experience “beating the house” as all such games are retired or completed with a profit to the operating charity. The celebration of the concept of “beating the house” provides a strong promotional value to games with finite lots of chances that are retired based upon the random early appearance of winning chances paying prizes of a certain value. This feature provides the unique opportunity to inform players that they can and have “beat the house” when the conditions have been met. For all finite games that are operated using the “major win rule,” meaning the game lot is completed and taken permanently out of play or retired once the last major winner has been awarded, the preferred method includes a graphic burst or celebration over the fact that players “beat the house” on that particular game lot prior to a new game lot being placed in play to replace the retiring game lot.

These and various other advantages and features of novelty which characterize the present invention are pointed out with particularity in the claims annexed hereto and forming a part hereof. However, for a better understanding of the invention, its advantages and objects obtained by its use, reference should be made to the drawings which form a further part hereof, and to the accompanying descriptive matter, in which there is illustrated and described a preferred embodiment of the present invention.

### BRIEF DESCRIPTION OF THE DRAWINGS

FIG. 1 is a display of a play station configured to be part of a network of play stations, the display showing six bar-style game activity meters, one for each six game lots of chances currently in play or offered for play for six different game titles available for play;

FIG. 2 is a display of a play station configured to be part of a network of play stations, the display showing a needle-style game activity meter;

FIG. 3 is an image of how bar-style game activity meters might appear on a sign above several play stations or terminals at a given location, for example;

FIG. 4 is a display of a play station configured to be part of a network of play stations, the display illustrating how icons (fishermen in the background) can be used to maintain a particular game theme to indicate the quantity of other play stations accessing the same game lot;

FIG. 5 is a display of a play station configured to be part of a network of play stations, the display depicting how the quantity of other play stations or terminals accessing the same game lot can be indicated by using a simple number to indicate the number of play stations accessing the same game lot within a given time period;

FIG. 6 is a display of a play station configured to be part of a network of play stations, the display indicating the average payout expectancy (APE) or, alternatively, it could display the average or actual profit or payout experience along with other game information; and

FIG. 7 is a display of a play station configured to be part of a network of play stations, the display illustrating an example of a graphic celebratory explosion displayed for the last major winning chance of a finite lot of winning chances has been purchased and the game has lost money on that particular game lot.

### DETAILED DESCRIPTION OF THE PREFERRED EMBODIMENTS

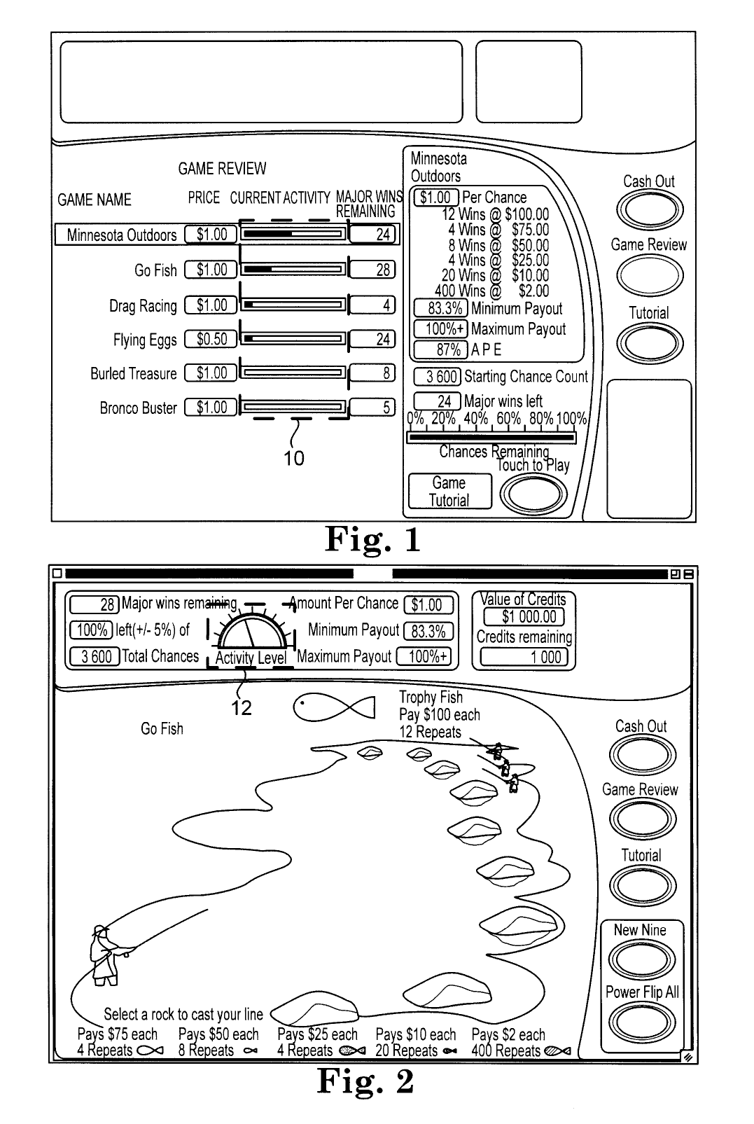

Various embodiments of the present invention are illustrated in FIGS. 1-7. Embodiments include a play station or game terminal including a computerized video display device or screen for playing games of chance and methods are disclosed for calibrating and visually indicating the frequency of chances randomly purchased from a particular game lot of chances accessed by all player stations electronically linked in a given time frame on a common network game server. The preferred game server is a processing unit that accesses the central game memory and randomly selects or vends chances and processes game status information, such as the frequency of chances sold, for display.

Providing players of electronic wagering gaming terminals or play stations an indication of the frequency at which chances are selling on a network of gaming terminals creates an aura of excitement. The play stations can be used for selecting, playing and wagering on games of chance that are linked to a central processing unit or server. This is especially the case when a plethora of gaming terminals or play stations are all accessing the same finite game lot having a finite number of chances including a pre-determined quantity of winning chances each having a predetermined prize value and a predetermined number of losing chances. With the finite number of winning chances, a player at one player station or when viewing a game promotional sign that includes this feature, may consider his prospects for randomly purchasing one of the winning chances when the player has information as to the quantity of major winning chances remaining and the frequency chances are being vended to all terminals accessing the same game lot. The game promotional sign is preferably an electronic sign external to the play stations that provides a list of available game lots or progressive prize linked games and also shows a game activity meter for each game lot promoted along with the quantity of remaining major winning chances. Preferably, the quantity of winning chances remaining for each prize value level of the winning chances remaining in the game lot is not displayed, only the aggregate quantity of all remaining major winning chances in the game lot is displayed.

As used herein, the term “major winner” or “major winning chance” preferably means any winning chance that awards a prize or has a prize value that is equal to or in excess of a threshold multiple of the price per single chance. The term “minor winner” or “minor winning chance” preferably means any winning chance that awards a prize or has a prize value less than the threshold multiple of the price per single chance. For example, the major winner threshold may be winning chances awarding 50 times the price of a single chance or above. It is envisioned that those who have access to electronic gaming device settings can set the definition as X and greater times the price of a single chance. Preferably, “X” is substantially higher than the price per chance.

Players seeking progressive prizes offered by a multi-location, multi-station network of gaming terminals, all of which are linked to the same particular progressive prize or game lot, may also find the information on how fast the chances are being vended on the network offering the same progressive prize or game lot both useful and interesting.

Preferably the computerized game includes a game activity meter or activity level meter that is a visual representation of the quantity of chances randomly purchased from a particular game lot over a predetermined recent time interval or scale parameter input. The scale parameter input is set by the party authorized to have access to game settings. The game meter is a visual representation of the frequency of play relative to the scale setting or scale parameter input. Example: The scale parameter input: number of chances (Q)______ sold over (T) ______ minutes or seconds=100, for example. If Q=200 sold over T=5 minutes, then 50 chances sold over that 5 minutes interval equals 25% of a full bar (as indicated in FIG. 1 or 25% of the scale provided in a needle style Game Activity Meter or Activity Level Meter (FIG. 2). The scale parameter input can be recalculated at preset intervals—every (F) ______ minutes or seconds.

FIG. 1 shows six bar-style game activity meters 10 “Current Activity”, one for each of the six different game lots in play and accessible by several terminals vending chances from the same finite game lots. In the situation of a network comprising a plurality of terminals, all terminals at a given location would be offering the same plurality of winning chances of a particular game lot. In the example shown in FIG. 1, the game “Minnesota Outdoors” is showing far greater play than the other five games available from this terminal or play station. The player thus might want to select a different game lot or title, such as “Drag Racing,” where the odds of randomly purchasing one of the plurality of winning chances may be perceived as greater. It is envisioned that chances can be randomly purchased with prepaid debit style cards, tokens or the like as commonly used in the gaming industry.

FIG. 2 shows a needle-style game activity meter or activity level meter 12 as it might appear on an individual game screen display, such as for the game “Go Fish.”

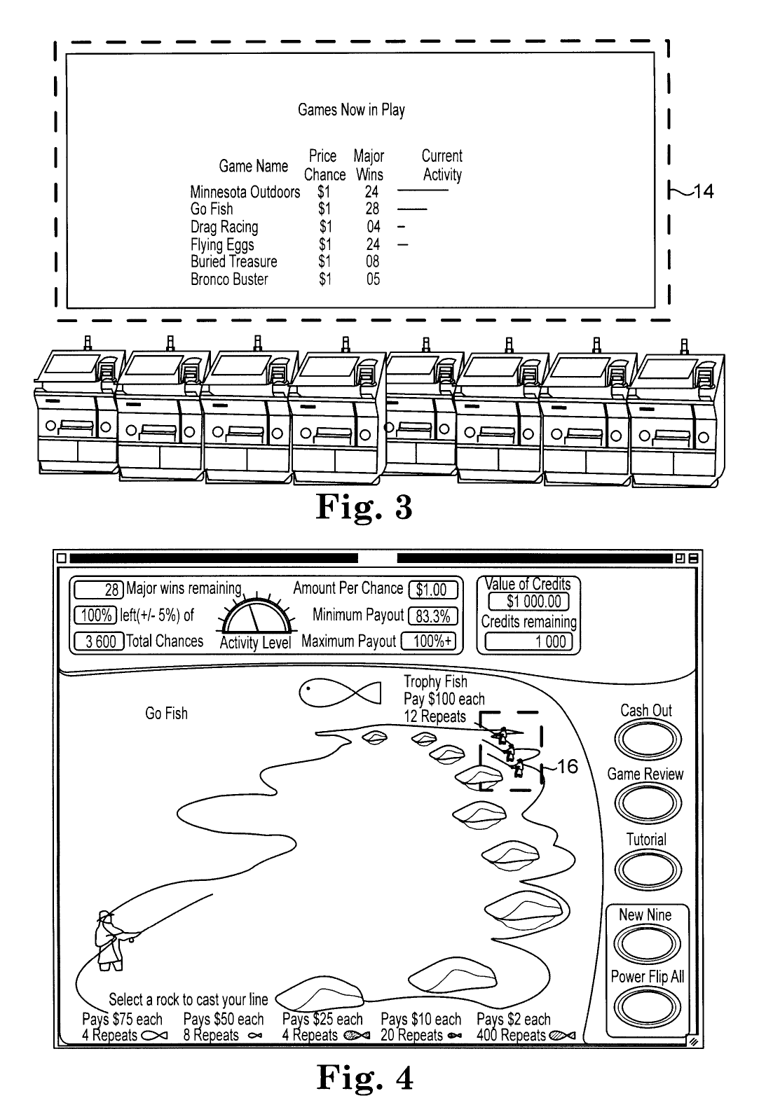

FIG. 3 shows how bar-style game activity meters 14 might appear on a promotional sign above several play stations or terminals (shown below the promotional sign). It is further envisioned that the game activity meters or activity level meters might also be televised as a promotion on a closed circuit television system for a casino property, restaurant, lounge or the like where the games are played. It is to be understood that the play stations or terminals illustrated below the game activity meters or activity level meters 14 sign are merely examples of the number, configuration and style of play stations and that other numbers, configurations and styles of play stations that can be used in accordance with the teachings of the present invention.

Terminals or Player Station's in Play—Icons or Numerals

A visual representation of the number of other terminals or players accessing the same game lot from a common network providing randomly purchasable chances to a network of player stations may also be provided.

Complimenting the information provided by the game activity meters or activity level meters, the display of information regarding how many other play stations or players are accessing or purchasing from the same game lot is believed to be of interest to players, who in effect, are competing for the remaining large or major winning chances in the game lot. It is believed that the quantity of player stations engaged in networks offering progressive prizes from multiple locations and jurisdictions is typically so large as to render this information of less value. Hence, this feature is aimed at networks comprised of multiple player stations accessing the same plurality of chances from the same game lot at the same casino or gaming venue.

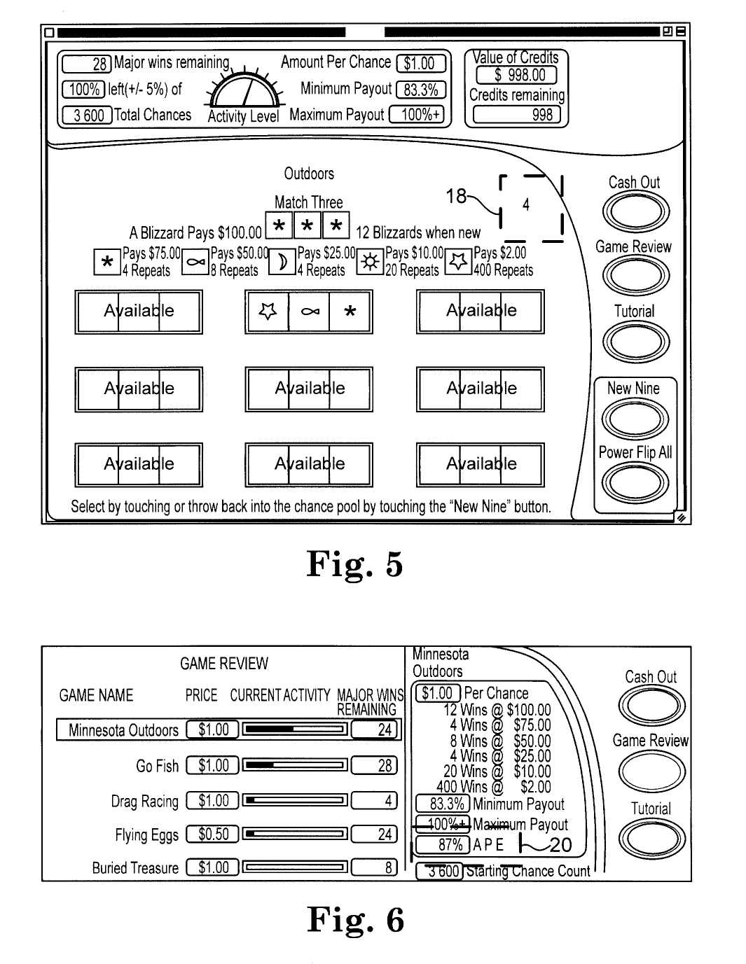

For purposes of defining “in play,” any player station that has purchased one of the plurality of randomly purchasable chances from the same game lot as other player stations on the network within a pre-set period of time shall be considered to be in play. For instance, any player station from which a chance has been purchased or vended within a certain period of time (e.g. the last 2 minutes) from a given lot of chances shall be considered to be in an “in play” status with regard to the lot of chances from which the randomly selected chance was purchased and therefore would be represented by an icon on the display screen for the particular game lot from which the chance was purchased. As generally illustrated in FIG. 4, a group of three fishermen 16 in the background indicate that three other play stations are in play. One method of indicating the number of play stations in play is a graphic icon (e.g. fishermen). This thematically provides players with the metaphor showing how many fisherman are currently fishing for the same “keepers” or “prize fish” or winning chances in the same pond. The graphic icon can vary by the theme or overall graphic appearance or theme of that particular game. In alternative embodiments, a number 18 might represent the quantity of other play stations actively randomly purchasing chances from the same game lot as other play stations on the network (see, for example, FIG. 5).

FIG. 4 demonstrates how icons that are in keeping with a particular game theme are preferably used to indicate the quantity of other stations accessing the same game lot having a plurality of chances. In the example shown for the game “Go Fish”, three fisherman icons are displayed on the far shore to indicate that three player stations are currently in play. This is one example of the use of a theme and it will be understood that other icons and themes may be used and are within the scope of the present invention.

FIG. 5 shows how the number of other player stations or terminals accessing the same game lot may be displayed by using a simple number. Thus, for the game “Minnesota Outdoors,” the number four 18 provides the information that four other player stations are in play for that game lot and randomly purchasing chances from the same game lot within the predetermined time period.

Display of “Average Profit or Payout Expectancy” and “Actual Profit or Payout Experience”

Some wagering/gaming jurisdictions require that players receive information on either the percentage a wagering game pays out or the percentage of profit expected from the wagered game. In some jurisdictions this actually has provided a competitive advantage to charity pulltab games. As compared with lottery games, charity pulltab games tend to payout significantly higher percentages. Yet, the percentages often posted for paper-based game lots, such as pull tab games, are inaccurate with payouts being understated and profits being overstated when and wherever the game lot is retired after all the major winning amounts have been won or purchased or, alternatively, when the quantity of major winning chances is below a certain preset quantity. The understatement of payouts and the overstatement of profits is a disadvantage where charity pulltab games are competing with casino slot machines that generally pay higher percentages in prizes.

In finite probability games of chance where the game lot in play is completed or permanently retired before all of the chances in a given lot are sold, the actual profit experience and actual payout experience can vary. As taught in U.S. Pat. No. 5,042,809 (Richardson), the disclosure of which is herein incorporated by reference, the preferred trigger for retiring a given lot or game is when all of the major winners in the lot have been won. This is especially the case if the game displays for player view, the aggregate quantity of “major winners” remaining among the game lot or pool of chances that are in play. Obviously, if no such major winners remain within the game lot, players are less likely to be attracted to play the game or purchase from that game lot. Therefore the entire game lot is preferably retired and is replaced by a new game lot, preferably of the same theme and chance characteristics as the previous game lot.

If a game lot is retired or taken out of play after all of the major winners have been purchased or redeemed, not only can the profit and payout vary but the owner or operator of the game can actually lose money for that particular game lot.

There are a number of methods for calculating how much on average certain finite lots of chances or game lots will profit and payout depending on the prize value of all possible winning chances and the quantity and value of major winning chances as compared to the price of a single chance and the total quantity of chances in the game lot. Statistically, over many repetitions of playing the same game lot, it can be calculated what the average profit and payout expectancy should be. This preferably constitutes the displayed or posted average profit expectancy or average payout expectancy for a particular game lot. After a set quantity of game lots have been placed in play and subsequently retired, the owner can convert to keeping a running average of the actual profit or payout over the completed game lots and post that statistic for the players. In FIG. 1, the Actual Payout Experience is designated as “APE.” It is envisioned that the game design company can set the average profit or payout expectancy and persons with access to the electronic gaming network settings can set the quantity of game lots that are to be completed before the statistic converts to actual profit or payout experience. Therefore, the actual profit experience or the actual payout experience is the expected profit or payout, respectively, until, for example, 20 or so games have been completed after which the average profit or payout expectancy statistic converts to being displayed as the actual profit or payout experience statistic, respectively. If the game has had miserable luck in the first few game lots, at least an advertising benefit may be obtained for the owner by showing players of the game are having a high actual payout experience or, alternatively, that the owner is experiencing a low actual profit experience.

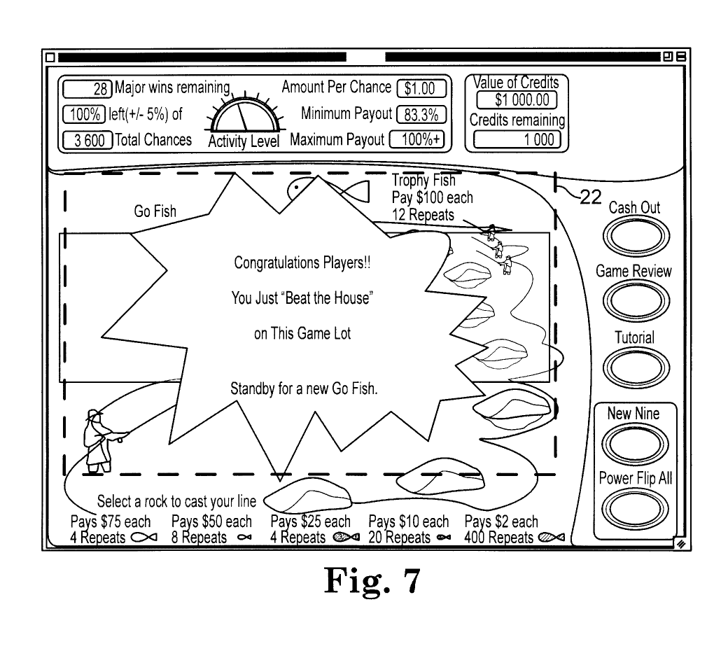

FIG. 6 shows how the average payout expectancy and Actual Payout Experience (APE) could be displayed 20, for example, along with other game information, once a predetermined number (e.g. 20) of game lots of chances from any particular game title has been completed. Alternatively, the actual profit experience and the actual payout experience could be displayed in similar manner. Preferably, the average payout expectancy or average payout experience are displayed because it is believed that the payout is typically higher and more attractive statistically than the actual profit experience and average profit expectancy.

If every chance in a finite game lot is sold and all winning chances are redeemed, the profit expectancy from that game lot can be determined by multiplying the total number of chances times the price per chance and then subtracting the total prize value of all winning chances. In stating this as a percentage as is preferred, the total value of payouts is divided by the total value of receipts from selling the chances. Where all chances are sold in a game lot, without any early retirement, the average profit expectancy should be the same as the average profit experience. If the finite game lot is retired out of play as soon as all major winning chances are redeemed or won, the actual profit experience is typically less than it would be if all of the chances are sold. Therefore, the actual payout experience is inversely higher than it would be if all of the chances are sold and the game lot is not retired.

In the game illustration of Table 1, the game lot includes 3,600 chances each selling at $1.00 and having a maximum payout or total prize value of $3,000, the average payout expectancy percentage is (3,000/3,600) 83.3%. If the remaining chances in the game are retired from play after all winning chances equal to or greater than the major winner threshold of $50 (50 times the cost per chance) have been redeemed, the statistical average payout expectancy would be (2,956/3456.96) 85.5% instead of 83.3%.

TABLE 1
Game Illustration.

| | Major winner threshold |
|---|---|
| Chance Price | (times per chance price) |
| $1.00 | 50 |

| | | Number | | | Game |
|---|---|---|---|---|---|
| | Individual | of | Total | | Lot |
| | Payout | chances | payout | Receipts | Profit |
| | $100.00 | 12.0000 | $1,200.00 | $12.00 | |
| | $75.00 | 4.0000 | $300.00 | $4.00 | |
| | $50.00 | 8.0000 | $400.00 | $8.00 | |
| | $25.00 | 4.0000 | $100.00 | $4.00 | |
| | $10.00 | 20.0000 | $200.00 | $20.00 | |
| | $2.00 | 400.0000 | $800.00 | $400.00 | |
| | $ — | 3152.0000 | $ — | $3,152.00 | |
| Subtotals | | 3600.0000 | $3,000.00 | $3,600.00 | $600.00 |
| Major winners | >=$50 | 24.0000 | $1,900.00 | $24.00 | |
| Minor winners | <$50 | 3576.0000 | $1,100.00 | $3,576.00 | |
| | | 3600.0000 | $3,000.00 | $3,600.00 | $600.00 |

| | | Proportion | Proportion | | | | |
|---|---|---|---|---|---|---|---|
| With early retirement | | chances | chances | | | | |
| (expected values) | | unsold | sold | | | | |
| Major winners | >=$50 | 0.00% | 100.00% | 24.0000 | $1,900.00 | $24.00 | |
| Minor winners | <$50 | 4.00% | 96.00% | 3432.9600 | $1,056.00 | $3,432.96 | |
| | | | | 3456.9600 | $2,956.00 | $3,456.96 | $500.96 |

In providing the average payout expectancy or, inversely, average profit expectancy, the average payout expectancy is preferably displayed until a predetermined quantity of game lots have been retired from play for a particular and specific game, all having the same title or name, theme, cost per chance, size of chance pool and payout configuration. After the predetermined quantity of game lots or chance pools have been retired, the actual payout or profit experience percentage is preferably displayed. The actual payout experience is calculated for each game lot by dividing the prize value for all randomly purchased prizes or winning chances for each game lot by calculating the actual payout experience percentage for each like game lot previously retired or completed (payout divided by receipts=A^{N}), adding the total payout percentages (A¹+A²+A³+ . . . A^{C}=B) and the dividing B by the quantity of previously retired like game lots C (B/C). One method of calculating the average profit expectancy is subtracting the actual payout experience from 100%.

The average payout expectancy and the actual payout experience can as easily be displayed in the converse as average profit expectancy and actual profit experience. The calculation of one statistic provides the calculation for the other statistic as briefly mentioned above. For example, if the actual payout experience is 87%, the actual profit experience is the percentage not paid out (in this case, 13%). Regulations may specify whether “Profit” or “Payout” statistics are required in any particular jurisdiction.

It will be understood that the game illustration of Table 1 is merely an example of how the embodiments of the present invention can be configured and the information contained in this illustration is not intended to be limiting in any way.

“Beat the House” Graphic Burst/Celebration

The concept of “beating the house” is incalculable with continuum-based electronic games, like slot machines because there is no point at which the game is completed or ends. Beating the house is a concept that cannot happen when games that are pre-designed to be profitable are played to their natural profitable conclusion. However, in a finite-probability game of chance that provides players with information on how many major winning chances remain unpurchased, it is desirable to take those game lots out of play or retire them permanently after the last available major winner is redeemed. This is because it is believed that players will not be attracted to play a game showing that no major winning chances remain or only minor winning chances remain. If the major winning chances that are randomly purchased among the other chances in the game lot have been awarded before enough losing chances in the game lot have been sold to cover the costs of the winning chances, that game lot loses money. This provides the unique opportunity to inform players that they can and have “beat the house” when the situation occurs. This celebration of “beating the house” provides at least a unique competitive promotional value to an unfortunate loss to the operator.

For all finite game lots that are operated in accordance with the major win rule, meaning the game is taken permanently out of play when the last major winning chance has been randomly purchased or awarded, there may be provided a graphic burst or celebration, for example, over the fact that players “beat the house” on that particular game lot prior to a new game lot being placed in play to replace the retiring game lot.

The graphic burst/celebration could, for example, be a static lively image that bursts onto the screen or some other active video sequence of images, such as fireworks bursting onto the screen accompanied by written acknowledgement that players have effectively “beat the house” on that particular game lot. For a game title or theme such as “Go Fish,” the graphic might include fish jumping all over the screen. The graphics used might be game theme specific or standard default graphics for many different game themes.

FIG. 7 shows a simple example of a graphic “Beat the House” celebratory explosion 22 for the last major winner being won in a finite lot of chances.

What is claimed is:

1. A method of displaying real time status of a computerized game on a computer gaming network, comprising:
providing a plurality of play stations connected to the network, each play station having a display; wherein a computerized game can be played on the network through any of the plurality of play stations; wherein the computerized game includes a game lot having a plurality of chances including only a finite number of winning chances plus a finite number of losing chances, each chance randomly purchasable via one of the play stations; wherein each winning chance has a prize value; and
displaying the frequency of game lot chances purchased for the game lot on the network on each display.

2. The method of claim 1, wherein the computerized game accesses a plurality of concurrently available different game lots; the method further comprising displaying via the display the frequency of chances being purchased for each concurrently available different game lot on the network.

3. The method of claim 1, further comprising displaying, as a percentage, the average payout expectancy, for the first game lot until a predetermined number of similarly configured game lots have subsequently been completed.

4. The method of claim 3, further comprising the step of displaying the actual payout experience after the predetermined number of similarly configured game lots have been completed; wherein the actual payout experience is a running average profit attained from each successive game lot completed after the predetermined number of game lots have been completed.

5. The method of claim 1, wherein the finite number of winning chances includes a plurality of major winning chances; wherein the method further comprises displaying the quantity of major winning chances remaining as available for purchase without indicating the prize value of each of the remaining available major winning chances; the method further comprising retiring the game lot when the quantity of major winning chances that have not been purchased in the game lot below a certain preset quantity.

6. The method of claim 1, wherein the frequency of game lot chances purchased is displayed through a dynamic graphic game activity meter indicating a visual representation of the quantity of chances purchased from the game lot over a predetermined recent time interval.

7. The method of claim 1, further comprising the step of indicating the quantity of play stations in play on the network purchasing chances from the same game lot.

8. The method of claim 1, further comprising the step of providing a game activity meter external of the play station.

9. A play station configured to be part of a network of play stations, the play station comprising:
a display; and
a computerized game, the computerized game including a game lot including a plurality of purchasable random chances, the plurality of chances having only a finite number of winning chances plus a finite number of losing chances; wherein each winning chance has a prize value;
wherein the computerized game displays via the display the frequency of game lot chances purchased from the game lot on the network.

10. The play station of claim 9, wherein the frequency is displayed with a game activity meter; wherein the game activity meter indicates a visual representation of the quantity of chances randomly purchased over a predetermined recent time interval.

11. The play station of claim 10, wherein the computerized game can access a plurality of concurrently available different game lots; wherein the computerized game displays via the display the frequency of chances being purchased for each concurrently available different game lot on the network.

12. The play station of claim 9, wherein the computerized game displays via the display the average payout expectancy.

13. The play station of claim 9, wherein the computerized game displays via the display the actual payout experience as a percentage; wherein the actual payout experience is a dynamic calculation of the average payout in each similarity configured game lot after a predetermined initial threshold quantity of similarly configured game lots have been completed.

14. The play station of claim 9, wherein the finite number of winning chances includes a plurality of major winning chances; wherein the quantity of major winning chances purchased is displayed without indicating the respective prize values of the major winning chances purchased.

15. The play station of claim 14, wherein the computerized game is retired when the quantity of major winning chances remaining in the game lot that have not been purchased is below a certain preset quantity.

16. The play station of claim 9, wherein the number of play stations in play on the network purchasing chances from the game lot is indicated via the display.

17. The play station of claim 9, wherein the computerized game displays via the display the average profit expectancy.

18. The play station of claim 9, wherein the computerized game displays via the display the actual profit experience as a percentage; wherein the actual profit experience is a dynamic calculation of the average profit in each game lot after a predetermined initial threshold quantity of game lots have been retired.
